(19) United States
(12) Patent Application Publication
(10) Pub. No.: US 2014/0244050 A1
(43) Pub. Date: Aug. 28, 2014

(54) Method and System for Detection of Endangering Situations in a Gas Pipe Construction

(71) Applicant: NLEAK Ltd., Yokneam (IL)

(72) Inventors: Dov Barkay, Ramat Ishay (IL); Omri Dotan, Zichron Yaacov (IL); Shaul Margalit, Givatayim (IL)

(21) Appl. No.: 14/275,415

(22) Filed: May 12, 2014

Related U.S. Application Data
(63) Continuation-in-part of application No. 14/118,418, filed on Apr. 11, 2014.
(60) Provisional application No. 61/486,445, filed on May 16, 2011.

(51) Int. Cl. G05D 7/06

(52) U.S. Cl. CPC G05D 7/0617
USPC 700/282

(57) ABSTRACT

System and method for identifying a situation that potentially endangers security in a gas pipe construction. The system includes: at least one detector such as a gas detector for detecting gas leaks and/or tremor detector for detecting endangering quake activity; a processor configured for receiving data from the one or more detectors, analyzing the receive data for identifying an endangering situation to the gas pipe construction; at least one shutoff unit configured for receiving alarm signals and closing at least one valve of the gas pipe construction when an alarm signal is received; and a controller configured for controlling each shutoff unit operation.

### CROSS-REFERENCE TO RELATED PATENT APPLICATIONS

This application is a continuation in part (CIP) of U.S. patent application Ser. No. 14/118,418 filed on Nov. 18, 2013, which is a national phase of international patent application No. PCT/IL2012/000191 filed on May 16, 2012, which is based on U.S. provisional patent application No. 61/486,445 filed on May 16, 2011.

### FIELD OF THE INVENTION

The present invention relates to the field of identification of gas leaks in pipes construction and more specifically to identification of leaks by using odor sensors.

### BACKGROUND OF THE INVENTION

The known systems in the art for detecting gas leak require wired communication which is integrated in the infrastructure of pipe construction. Such system can't be implemented in gas construction of domestic use. Accordingly there is a need for gas detection system which can be integrated with existing domestic gas infrastructure.

### BRIEF SUMMARY

According to some embodiments of the invention, there is provided a system for identifying a situation that potentially endangers security in a gas pipe construction, wherein the system comprises: at least one detector configured for sensing an endangering situation; at least one processor configured for receiving data from the at least one detector, analyzing the receive data for identifying an endangering situation to the gas pipe construction and transmitting alarm signals upon identification of an endangering situation; at least one shutoff unit configured for closing at least one valve of the gas pipe construction when an alarm signal is received; and a controller configured for receiving alarm signals from the at least one processor and controlling operation of the at least one shutoff unit in response to received alarm signals.

Optionally, the at least one detector comprises at least one of: at least one gas detector comprising an odor sensor for detecting gas leaks; and/or at least one tremor detector comprising a tremor sensor for detecting an endangering quake activity. The tremor detector may be for instance an accelerometer.

According to some embodiments, the at least one processor is embedded in each of the at least one detector. The at least processor may be embedded in the controller. The detector optionally allows operating the tremor sensor thereof in at least two modes of sampling: a sleep mode having a low sampling rate and a high-rate mode having a sampling rate that is substantially higher than that of said sleep mode, the tremor detector being configured to identify a suspicious quake activity by analyzing the received signals from the tremor sensor when in sleep mode and switch the sleep mode of the tremor sensor to a high-rate mode if a suspicious quake activity is identified. A signal sample of a predefined time interval from the tremor sensor when in the high-rate mode is analyzed to identify an endangering quake activity requiring shutoff of the valve.

According to some embodiments, at least one of the at least one detector is embedded in the shutoff unit.

Optionally, the processor is a central unit configured for receiving data from the detectors for having the processor identifying endangering situations by analyzing data from each of the detectors. The system may further comprise a plurality of shutoff units each integrated in a faucet of a different valve of the gas pipe construction, wherein the controller is configured to control the shutoff units according to data received from the processor.

Each shutoff unit may optionally further comprise an actuator unit, a spring and a disk connected to the valve and associated with the spring, wherein upon activation of the actuating unit by said controller the spring is released, changing the valve position through the disk motion to a close position.

According to some embodiments, the shutoff unit further comprises a motor for rotating the disk, wherein the motor is configured to be operated upon receiving signals from the controller.

Optionally, each shutoff unit comprises a DC motor, a gear set, a printed circuit board (PCB), at least one mobile power source powering the PCB, micro-switch and DC motor, at least one micro-switch, wherein the PCB is configured to receive a signal from the processor of the system indicative of a request to shutoff the valve and operate said DC motor via the micro-switch to rotate the gear set such as to allow mechanical closing of the valve by the gear set.

The gear set optionally comprises at least one cogwheel rotatable by said DC motor at least one of the cogwheel has a protrusion configured' to be blocked by a stopper connected to the micro-switch for limiting rotational movement of the cogwheel to have the micro-switch switch said DC motor off when the protrusion reaches the stopper for fully shutting off the valve.

According to other aspects of the invention, there is provided a method for identifying endangering situations relating to a security in a gas pipe construction, comprising the steps of: sensing at least one parameter related to gas pipe construction related endangering situations, using at least one detector; receiving data from the at least one detector; analyzing the received data to identify endangering situations; and upon identification of an endangering situation transmitting an alarm signal to a controller that controls at least one shutoff unit of the gas pipe construction; upon receiving an alarm signal, closing at least one valve of the gas pipe construction by using the at least one shutoff unit.

Optionally, the sensing comprising sensing at least one: gas leak by using a gas detector comprising an odor sensor; and/or quake activity, using a tremor detector comprising a tremor sensor.

The tremor sensor is optionally an accelerometer.

According to some embodiments, the gas detector is configured for allowing identification of gas leaks by comparing value of output of the odor sensor thereof to a predefined threshold.

According to some embodiments, an endangering quake activity identification comprises the steps of: analyzing data from the tremor sensor when in a sleep mode in which the tremor sensor measures in low sampling rate for identifying a suspicious quake activity; upon identification of a suspicious quake activity switching the sampling rate mode of the tremor sensor into a high-rate mode, in which the sampling rate is substantially higher than that of the sleep mode; analyzing data from the tremor sensor when in the high-rate mode for identifying an endangering quake activity; switching the sampling rate mode back to sleep mode if no endangering quake activity is identified and repeating the above steps; and upon identification of an endangering quake activity, transmitting a signal indicative of the identified endangering quake activity to at least one of the at least one shutoff unit for closing said at least one valve thereof for securing the gas pipe construction.

### BRIEF DESCRIPTION OF THE DRAWINGS

The present invention will be more readily understood from the detailed description of embodiments thereof made in conjunction with the accompanying drawings of which:

FIG. 1 is a block diagram illustrating components of a leak detection system according to some embodiments of the invention;

FIG. 2 is a block diagram illustrating a shutoff unit design for the leak detection system, according to some embodiments of the invention.

FIG. 3 is a block diagram the detection unit according to some embodiments of the invention;

FIG. 4 is an illustration the flow leak detection process according to some embodiments of the invention;

FIG. 5 is an exploded view of the shutoff unit components according to some embodiments of the invention.

FIG. 6 is an illustration of the detection unit according to some embodiments of the invention.

FIGS. 7A and 7B show systems for identification of gas leaks and quake activity endangering situations and controlling shutoff of a gas pipe construction according to such situations identification, according to some embodiments of the invention: FIG. 7A shows a system for identification for endangering situations having a single gas detector having an odor sensor and a single tremor detector; and FIG. 7B shows a system for identification for endangering situations having multiple gas detectors and multiple tremor detectors for controlling multiple shutoff units.

FIG. 8 shows a flowchart illustrating a process of identification of gas leaks and/or quake activity related situations and controlling a shutoff unit of a gas pipe construction in response to such identification, according to some embodiments of the invention.

FIGS. 9A-9E show a valve system having a shutoff unit installed thereto for controlling shutoff of a valve of a gas pipe construction, upon identification of gas or quake endangering situation, according to some embodiments of the invention: FIG. 9A shows a front view of the valve system; FIG. 9B shows a rear view of the valve system; FIG. 9C shows the shutoff unit of the valve system; FIG. 9D shows an isometric lower view of the valve system; and FIG. 9E shows a front view of the valve system in which the handle of the valve is transparent to show the shaft it is configured to rotate for controlling closing and opening of the valve.

### DETAILED DESCRIPTION OF SOME EMBODIMENTS OF THE INVENTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

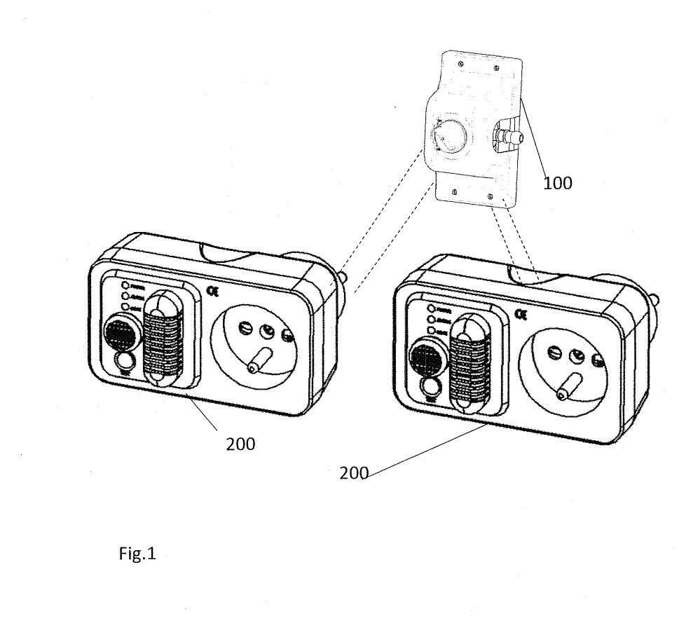

FIG. 1 illustrates the main components of the gas leak detection system implemented in pipe construction system according to some embodiments the present invention. The system includes, shutoff unit 100 positioned at an entrance point which includes a gas supply interface unit connected to inner wall of the building in which the pipe construction is installed and at least detection devices 200 positioned in the same space of the gas entrance point location. The shutoff valve communicates through wireless communication link with the detection devices 200 and the shutoff unit 100. The detection unit identifies odor related to the gas running within the pipe construction and transmits a signal through a wireless network to the shutoff gas unit. The shutoff unit is integrated with an existing entrance valve interface connected the inner wall surface of a building. According to some embodiments of the present invention, it is suggested to include more than one detection device in each space, each detection device is designed to identify different type of gas, such Co or Butane gas. Each detection unit may have different sensors and apply different tests to identify plurality of gas types. Some sensors may require only battery energy source and other may require to be connected to AC power supply.

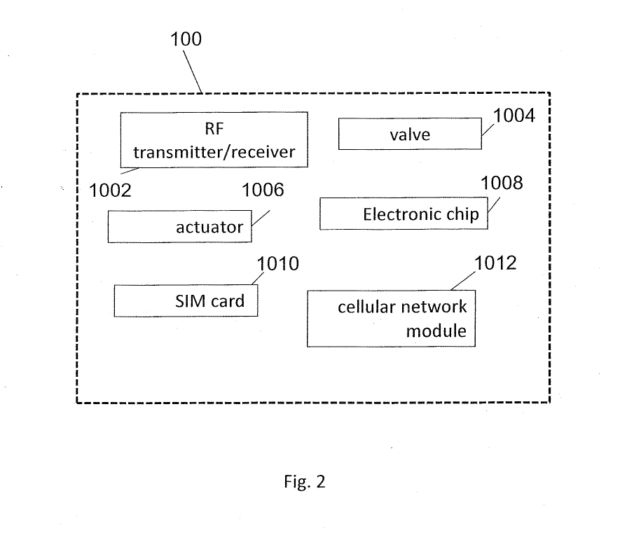

FIG. 2 is a block diagram illustrating of the shutoff unit design according to some embodiments of the invention. The shutoff unit comprises a communication module 1002 such as an RF transmitter for communicating with the detection units, a valve unit 1004 for closing the entrance interface, actuator such as electromagnet unit 1006 for operating the valve and an electronic chip 1008 for operating the actuator. According to some embodiments of the present invention it is suggested to add cellular network module 1010 (Such as GSM module) and a SIM card 1012 for enabling reporting alerts of identified leaks to predefined users phone numbers associated to technical support of the pipe construction.

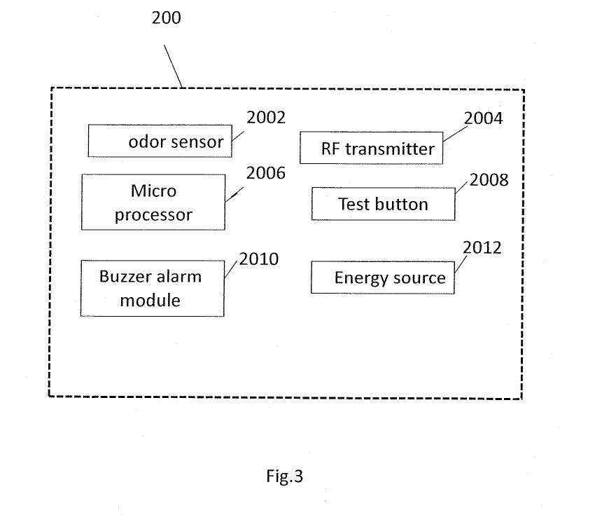

FIG. 3 is a block diagram of the detection unit design according to some embodiments of the invention. The detection unit comprises an odor sensor 2002 for measuring odor presence, a transmitter unit 2004 for sending signal indicating of odor detection exceeding a predetermined level, a microprocessor 2006 including an algorithm for determining gas level according to sensor measurements, test module 2008 enabling to test the sensor operation, buzzer alarm module 2010 enabling to activate sound alarm in cases the gas concentration is the air has exceeded predefined level and an energy source such as battery or transformation for connecting AC power supply.

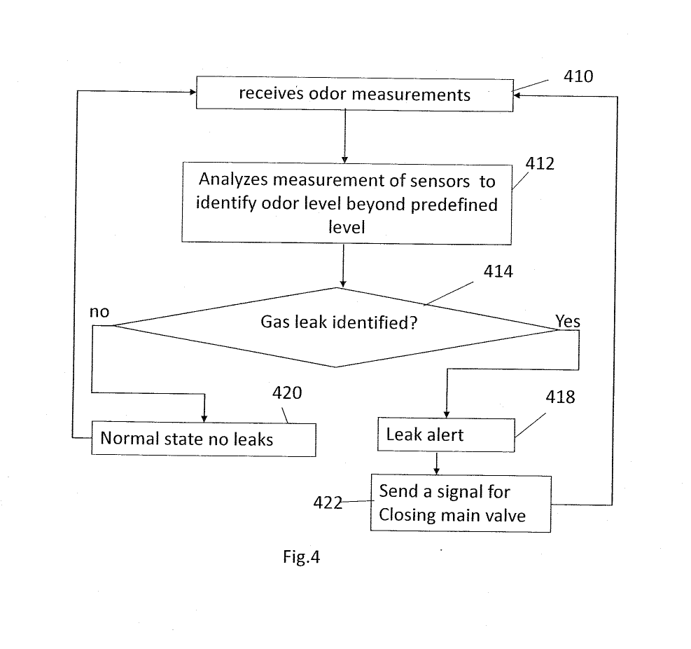

FIG. 4 is an illustration the flow leak detection process according to some embodiments of the invention. The detection units receive odor measurements (step 410) and analyzes data for identifying measurements which exceeds a predefined level (step 412). Based on this analysis, the detection unit determines if there is a gas leak. In case of positive detection, an alert message may be generated (step 418) and control signal is sent (step 422) to the shutoff unit entrance point for closing the valve, otherwise the normal state proceeds (step 420).

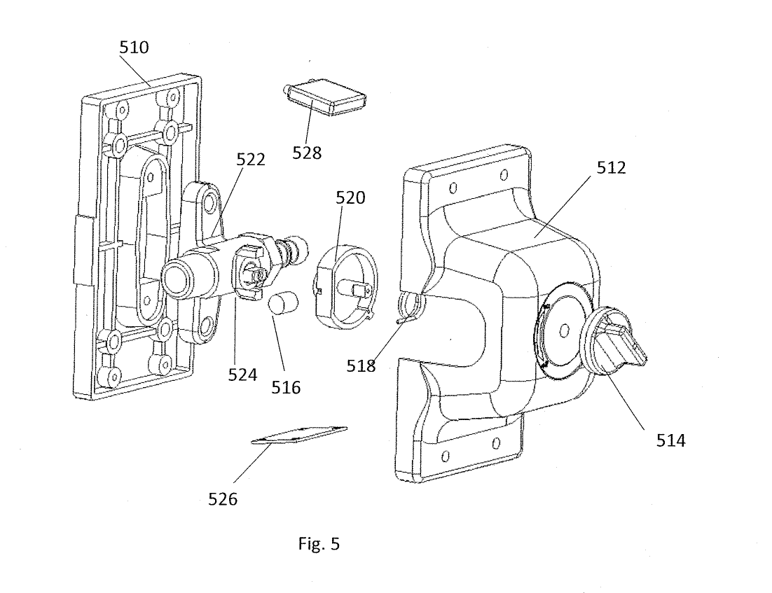

FIG. 5 is an exploded view of the shutoff unit components according to some embodiments of the invention. The shutoff unit is integrated with an existing entrance valve housing including: an enclosure base 510 and enclosure top 512. Within the housing are located: A valve 522 which is part of exiting entrance interface, a disk 520 which is associated with spring 518, an actuating unit 516, a PCB unit 516 and a battery 528. The actuating unit is controlled by the PCB unit 526, which receives the detection signals from the detection unit. Upon receiving a positive detection signal the PCB activates the actuator 516 to release the spring 518. Upon releasing, the valve changes position to close state. The valve can be controlled manually by the button 514.

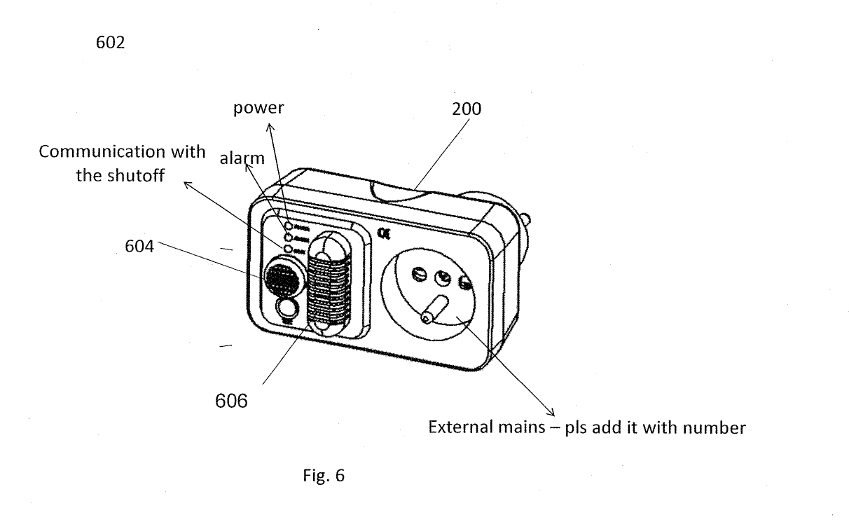

FIG. 6 is an illustration of the detection unit according to some embodiments of the invention. The detection unit may include a led indicator 602 for verifying activation of the unit, a buzzer button 604 for activating an alarm and odor sensor 606.

According to some embodiments of the present invention the system includes Seismometer detection unit for identifying seismic waves which indicate of earthquake. This detection located in the same space of the shutoff unit wherein upon detecting an earthquake, a signal is transmitted to the shutoff unit for closing the valve.

According to some embodiments of the present invention the system may include plurality of detection devices and operating unit for controlling the devices, installed in an industrial kitchen facility. Each detection device is positioned nearby one at least one stove and transmits signals to the operating unit. The operating unit receives the signals indicating of a gas leak, from the different detection units and sends lock instruction to the corresponding shutoff unit. Industrial kitchen facility may include more than one shutoff unit, where the operating units coordinates the detection units signals, sending the lock instruction to relevant shutoff units. The operating units may further include communication units such as GSM, sending electronic messages such as SMS to relevant personal.

According to some embodiments of the present invention the operating unit may integrate the control of shutoff unit of two types, one type of gas shutoff unit as disclosed herein, and shutoff unit of water

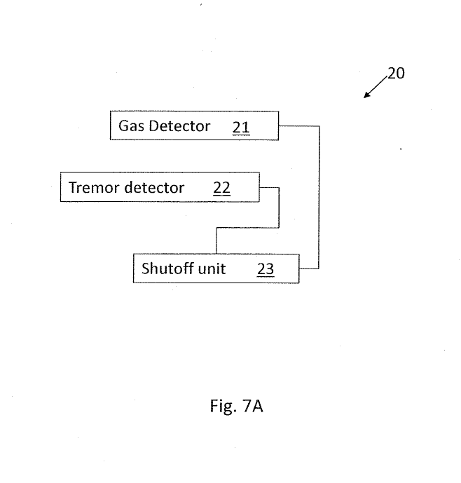

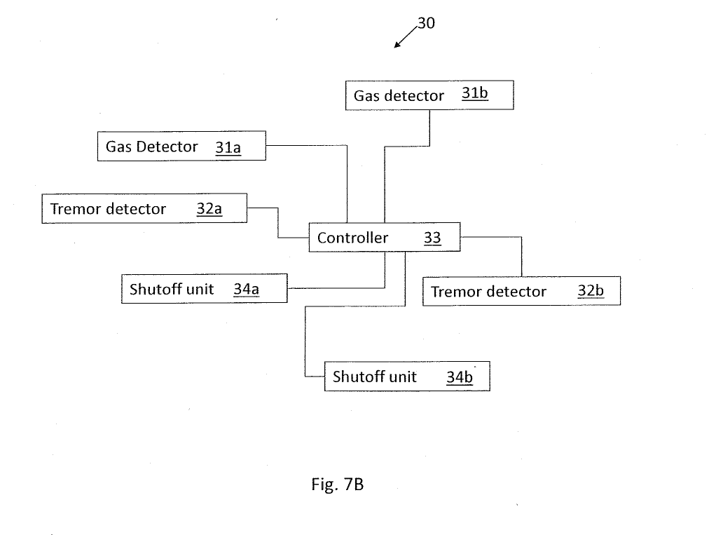

FIGS. 7A and 7B show systems 20 and 30 for identification of gas leaks and quake activity endangering situations and controlling shutoff of a gas pipe construction according to such situations identification, according to some embodiments of the invention.

The term tremor or quake activity referred to herein refers to any tremor activity such as shaking that causes tremors to the pipe construction or one or more parts thereof.

FIG. 7A shows a system 20 for identification for endangering situations having a single gas detector 21 configured for detection of gas leaks, optionally having an odor sensor and a processor that can process the sensor data for gas leak identification and a tremor detector 22 configured for detecting earthquakes related endangering situations. The detectors 21 and 22 are operatively communicable with a shutoff unit 23 configured for receiving signals form the detectors 21 and 22 indicative of an endangering situation requiring shutting off one or more valves of the pipe construction and controlling shutting off those valves in response. The shutoff unit 23 may have a controller embedded therein such as a digital board for communicating with the detectors 21 and 22 as well as for electronically or digitally controlling the mechanical shutting off of the gas pipe construction valves(s). The communication between the detectors 21 and 22 and the shutoff unit 23 may be any know in the art communication such as electrical communication via electric wires, wireless communication such as RF based communication e.g. WiFi, Bluetooth and the like or optical communication such as infrared (IR) based communication. The gas detector 21 may be located such as to optimize gas leak detection via its odor sensor while the location of the tremor detector 22 may be such as to optimize quake activity detection. This means that the detectors 21 and 22 may be located in different locations in respect to the piper construction or over the pipeline thereof for instance.

FIG. 7B shows another system 30 for identification for endangering situations having multiple gas detectors such as 31a and 31b, multiple tremor detectors such as 32a and 32b all connecting or communicating via a unified controller 33 configured for collecting data from all detectors and processing the received data for determining whether one or more of multiple shutoff units 34a and 34b of the pipe constructions should be closed. The controller 33 further controls operation of the shutoff units 34a and 34b e.g. by transmitting a shutoff signal identifiable by each of the shutoff units 34a and 34b via a communication link (wireless or via communication or electric wires). For example, upon identification of a gas leak associated with one of the valves of the pipe construction the controller 33 may choose to either shut off one or more of the valves of the pipe construction depending on severity of the leak and location thereof. The locations of the gas detectors 31a-31b may be defined for improving identification of the gas leak.

According to some embodiments, the tremor detector is configured for detecting tremors and transmitting a signal if the tremor activity detected thereby exceeds a threshold of frequencies amplitudes. To do so a processor embedded in the tremor detector or a processor external thereto may be designed to process the signal outputted by a sensor of the detector such as a piezoelectric based transducer sensor for identifying the frequencies of the tremor activity and their associated peaks (e.g. via Furrier Transform of the output electric signal of the transducer), while certain combinations of frequencies with amplitudes exceeding certain predefined thresholds may be considered as an endangering quake situation. The endangering situation may be a result of any tremor related activity such as an intensive seismic activity (earthquake) or shakings caused by other causes such as construction work done in proximity to the pipe construction causing it to shake to a level that can cause damage to the pipeline and thereby gas leaks and the like.

The controller 33 may be designed to automatically transmit a signal ordering the shutoff units to close upon identification of one of the optional endangering situations.

According to some embodiments, the gas and tremor detectors 31a-32b may be set to transmit their data at predefined time intervals to the controller 33.

According to some embodiments, any one of the tremor detectors of the present invention includes a tremor sensor such as an accelerometer or a transducer and a processor such as a microchip and has two or more sampling modes. The default mode may be a “sleep mode” in which the sampling rate is substantially low for requiring much less battery power. Once the processor identifies a signal of a suspicious quake activity it switches the sampling mode of the sensor into a “high mode” of a higher sampling rate, which is substantially higher than that of the sleep mode. For example, in the sleep mode the sampling rate may be a few minutes while the high mode the sampling rate may be of a few seconds. The final decision for detection of an endangering quake activity may be done at the processor of the detector or at an external processor of a main controller. The tremor detector may only send a signal to the external controller when it is in the high mode to avoid false alarms.

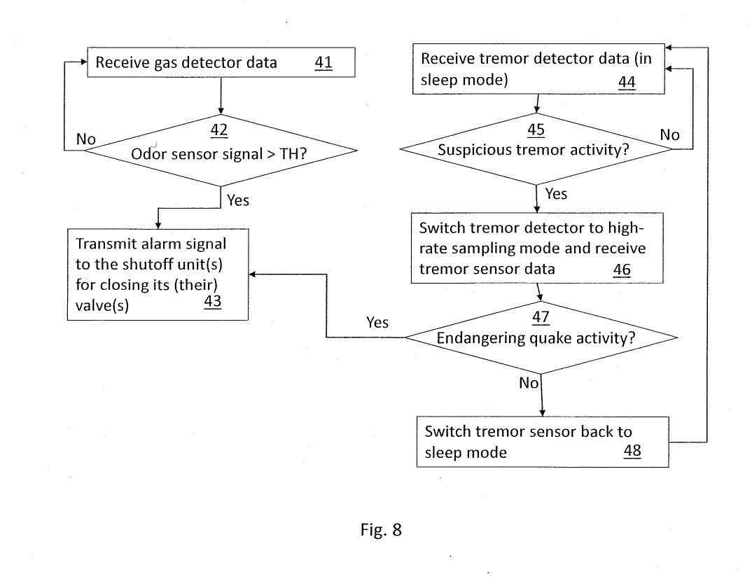

FIG. 8 shows a flowchart illustrating a process of identification of gas leaks and/or quake activity related situations and controlling a shutoff unit of a gas pipe construction in response to such identification, according to some embodiments of the invention. Data received from the gas detector 41 is analyzed by a processor embedded in the detector or an external controller processor to identify gas leak 42 e.g. by checking that a parameter value deduced from the odor sensor data of the gas detector such as concentration of gas molecules) does not exceed a predefined gas threshold value. If the value exceeds the threshold, a gas leak is identified and an alarm signal indicative of the endangering situation is transmitted to the one or more shutoff units of the system to automatically close the one or more valves of the pipe construction 43. Simultaneously to the gas detection process, a quake activity detection process is carried out using the tremor detector of the system. The data from the tremor detector when in a default sleep mode (e.g. accelerometer data) is received at a processor of the detector 44 and processed to identify a suspicious tremor activity 45. Once such suspicious activity is identified the sensor of the tremor detector such as the accelerometer or transducer thereof is switched to the high mode for increasing sampling rate 46. In the high mode the data of the sensor is processed and analyzed again to check if an endangering quake activity is identified 47. If no such endangering activity is identified the sensor is switched back to the sleep mode and the process 44-47 is repeated. If an endangering quake activity is identified a signal is sent to the one or more shutoff units for operating thereof to close the one or more valves of the pipe construction 43.

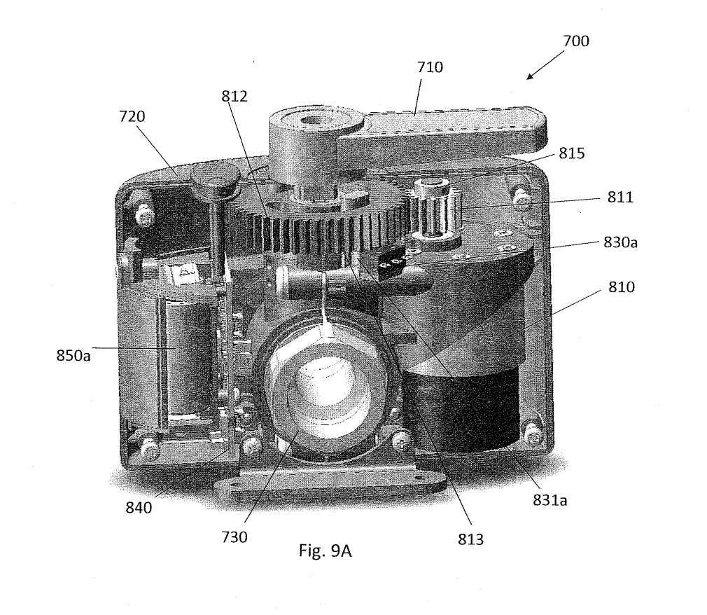

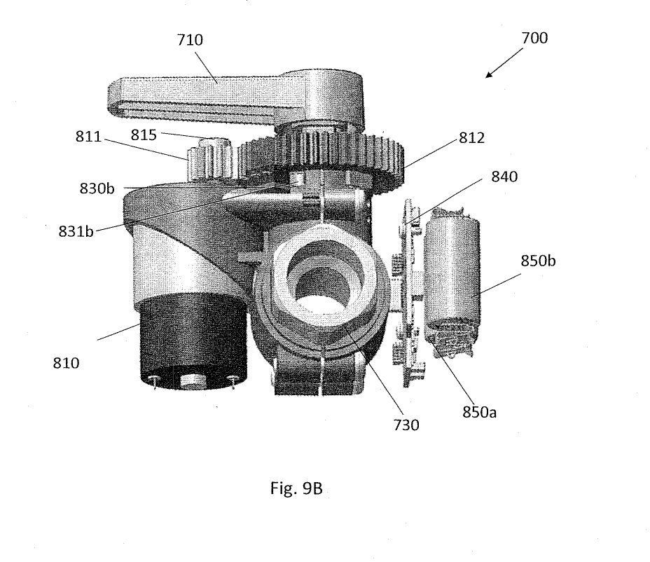

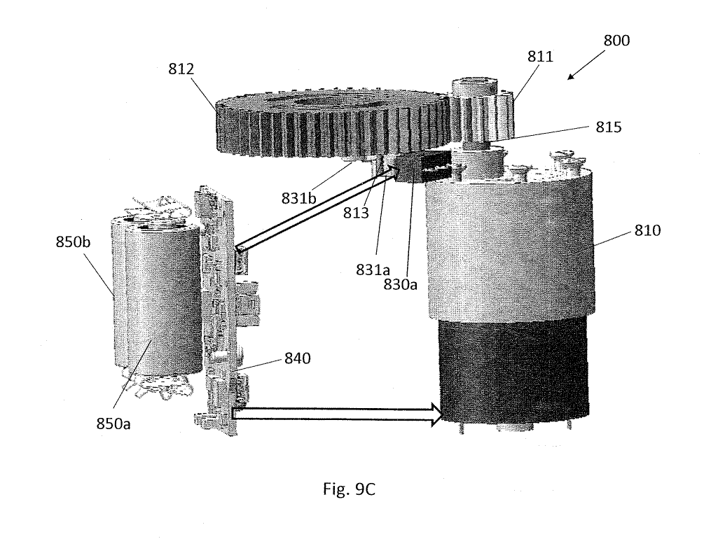

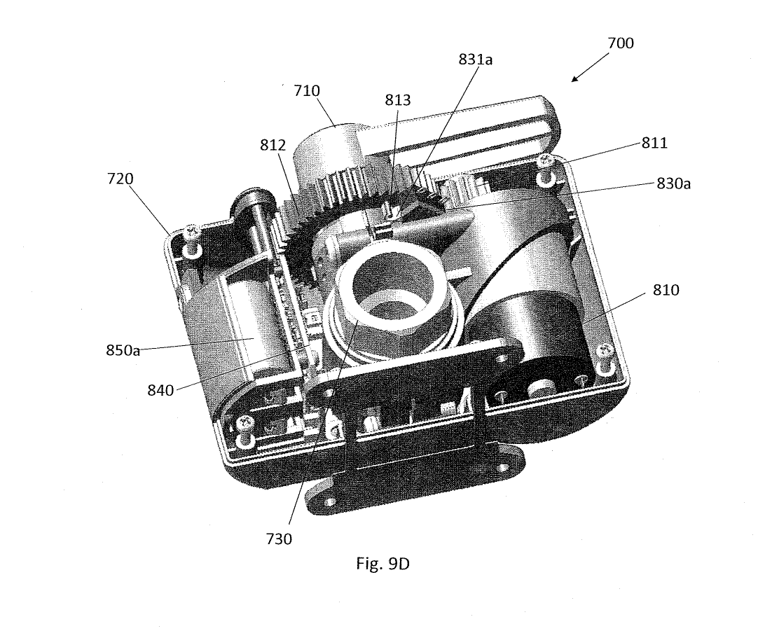

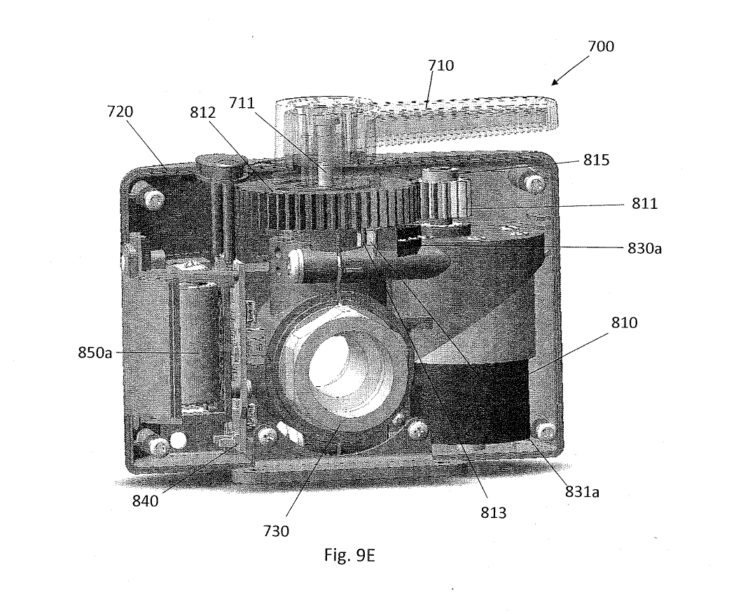

FIGS. 9-9E show a faucet of a valve system 700 having a shutoff unit 800 installed therein for controlling shutoff of a valve of the gas pipe construction, upon identification of gas or quake endangering situations, according to some embodiments of the invention. The endangering situation identification (gas leak or quake activity) may be carried out at a remote processor of a central controller of the system or at the gas and tremor detectors, which may be externally located in respect to the valve system 700. The shutoff unit 800 comprises a printed circuit board (PCB) 840 powered by one or more batteries such as batteries 850a and 850b. The PCB 840 is configured for receiving signals from a remote controller or from the gas and tremor detectors of the system indicating that the valve of the valve system 700 should be closed (shut off) and operating the actual mechanical closing of the valve.

The valve system 700 includes a casing 720, a mechanical actuator 710 for mechanically closing and opening of the valve, a pipeline connector 730 connecting to the gas pipeline and a spherical valve (not shown) configured for being positioned inside an opening of the pipeline connector configured for being moved to open and close fluid passage therethrough. The actuator 710 includes a rotatable shaft 711 (see FIG. 9E) which is rotated to move the spherical valve along a slotted groove for controlling the passage flow through opening of the pipeline connector 730.

According to some embodiments, as shown in FIGS. 9A-6E, the shutoff unit 800 includes the PCB 840 and batteries 850a and 850b, one or more micro-switches, such as micro-switches 830a and 830b, a gear set including one or more gears such as a first cogwheel 811 and a second cogwheel 812, a DC motor 810 and a motor axle 815 rotatable by the DC motor. The first cogwheel 811 of the gear set is coaxially connected to the DC motor axle 815 for being routed thereby. The first cogwheel 811 meshes the second cogwheel 812 for rotating thereof. The second cogwheel 812 has a protrusion 813 connected to a bottom side thereof as shown in FIGS. 9A, 9C and 9E, configured for clocking the rotation of the second cogwheel 812 when reaching a stopper 831a or 831b of one of the micro-switches 830a and 830b. The DC motor 810 is designed to rotate the axle 815 thereof to a certain rotational span such as only 90 degrees of a rotational spin to allow the protrusion 813 to reach the stopper 831a for closing the valve. Having the protrusion 813 reach the stopper 831a may operate the micro-switch 831a for shutting the DC motor 810 off after a partial rotation of the second cogwheel 812.

The PCB 840 is configured for receiving a signal for shutting off the valve system 700 upon gas leak or endangering quake activity identification, and transmitting a signal to the one or more micro-switches 830a and 830b for physically and mechanically rotating the shaft 711 for closing the valve of the valve system 710. Once receiving the signal from the PCB 840, the micro-switches 830a and 830b operate the DC motor 810 for rotating the axle 815 thereof thereby mechanically causing the rotation of the cogwheel 812 for (i) rotating the shaft 711 connected thereto for closing the valve and (ii) for reaching a predefined rotational position by being blocked by the stopper 831a.

As shown in FIG. 9C the PCB 840 communicates with the micro-switches 830a and 830b via a communication link that may be wired or wireless such as via, an electric cabling communication, optical communication RF communication and the like. Similarly, the micro-switch communicates with the DC motor 810 for operating thereto via another similar or different communication link.

As illustrated in FIGS. 9A-9B, 9D-9E, the shutoff unit 800 is configured for being integrated with a standard valve system 700 by connecting directly to its gas faucet. The faucet may be a main faucet of a gas pipeline connecting to pipelines of a gas system, or an end point faucet connecting to a gas facility or appliance.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not to be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A system for identifying a situation that potentially endangers security in a gas pipe construction, said system comprising:
at least one detector configured for sensing an endangering situation;
at least one processor configured for receiving data from said at least one detector, analyzing the receive data for identifying an endangering situation to the gas pipe construction and transmitting alarm signals upon identification of an endangering situation;
at least one shutoff unit configured for closing at least one valve of the gas pipe construction when an alarm signal is received; and
a controller configured for receiving alarm signals from said at least one processor and controlling operation of said at least one shutoff unit in response to received alarm signals.

2. The system according to claim 1, wherein said at least one detector comprises at least one of: at least one gas detector comprising an odor sensor for detecting gas leaks; and/or at least one tremor detector comprising a tremor sensor for detecting an endangering quake activity.

3. The system according to claim 2, wherein said tremor sensor is an accelerometer.

4. The system according to claim 1, wherein each of said at least one processor is embedded in each of said at least one detector.

5. The system according to claim 1, wherein said at least processor is embedded in said controller.

6. The system according to claim 2, wherein said detector allows operating said tremor sensor thereof in at least two modes of sampling: a sleep mode having a low sampling rate and a high-rate mode having a sampling rate that is substantially higher than that of said sleep mode,
wherein said tremor detector being configured to identify a suspicious quake activity by analyzing the received signals from said tremor sensor when in sleep mode and switch the sleep mode of said tremor sensor to a high-rate mode if a suspicious quake activity is identified, wherein a signal sample of a predefined time interval from said tremor sensor when in the high-rate mode is analyzed to identify an endangering quake activity requiring shutoff of the valve.
The system according to claim 1, wherein at least one of said at least one detector is embedded in said shutoff unit.

7. The system according to claim 1, wherein said processor is a central unit configured for receiving data from a plurality of said detectors for having said processor identifying endangering situations by analyzing data from each of said detectors.

8. The system according to claim 7, wherein said system comprises a plurality of shutoff units each integrated in a faucet of a different valve of the gas pipe construction, wherein said controller is configured to control said plurality of shutoff units according to data received from said processor.

9. The system according to claim 1, wherein said shutoff unit further comprises an actuator unit, a spring and a disk connected to the valve and associated with the spring, wherein upon activation of the actuating unit by said controller the spring is released, changing the valve position through the disk motion to a close position.

10. The system according to claim 9, wherein said shutoff unit further comprises a motor for rotating said disk, said motor is configured to be operated upon receiving signals from said controller.

11. The system according to claim 1, wherein each said at least one shutoff unit comprises a DC motor, a gear set, a printed circuit board (PCB), at least one mobile power source powering said PCB, micro-switch and DC motor, at least one micro-switch,
wherein said PCB is configured to receive a signal from the processor of said system indicative of a request to shutoff said valve and operate said DC motor via said micro-switch to rotate said gear set such as to allow mechanical closing of the valve by said gear set.

12. The system according to claim 11, wherein said gear set comprises at least one cogwheel rotatable by said DC motor at least one of said cogwheel has at least one protrusion configured to be blocked by a stopper connected to said micro-switch for limiting rotational movement of said cogwheel to have the micro-switch switch said DC motor off when said protrusion reaches said stopper for fully shutting off said valve.

13. A method for identifying endangering situations relating to a security in a gas pipe construction, said method comprising the steps of:
sensing at least one parameter related to gas pipe construction related endangering situations, using at least one detector;
receiving data from said at least one detector;
analyzing the received data to identify endangering situations; and
upon identification of an endangering situation transmitting an alarm signal to a controller that controls at least one shutoff unit of the gas pipe construction;
upon receiving an alarm signal, closing at least one valve of the gas pipe construction by using said at least one shutoff unit.

14. The method according to claim 13, wherein said sensing comprising sensing at least one: gas leak by using a gas detector comprising an odor sensor; and/or quake activity, using a tremor detector comprising a tremor sensor.

15. The method according to claim 14, wherein said tremor sensor is an accelerometer.

16. The method according to claim 14, wherein said gas detector is configured for allowing identification of gas leaks by comparing value of output of said odor sensor thereof to a predefined threshold.

17. The method according to claim 14, wherein an endangering quake activity identification comprises the steps of:
analyzing data from the tremor sensor when in a sleep mode in which the tremor sensor measures in low sampling rate for identifying a suspicious quake activity;
upon identification of a suspicious quake activity switching the sampling rate mode of the tremor sensor into a high-rate mode, in which the sampling rate is substantially higher than that of the sleep mode;
analyzing data from the tremor sensor when in the high-rate mode for identifying an endangering quake activity;
switching the sampling rate mode back to sleep mode if no endangering quake activity is identified and repeating the above steps; and
upon identification of an endangering quake activity, transmitting a signal indicative of the identified endangering quake activity to at least one of said at least one shutoff unit for closing said at least one valve thereof for securing the gas pipe construction.
